(19) United States
(12) Patent Application Publication
(10) Pub. No.: US 2012/0002236 A1
(43) Pub. Date: Jan. 5, 2012

(54) IMAGE FORMATION APPARATUS

(75) Inventor: Toyoshi EBISUI, Tokyo (JP)

(73) Assignee: OKI DATA CORPORATION, Tokyo (JP)

(21) Appl. No.: 13/168,002

(22) Filed: Jun. 24, 2011

(30) Foreign Application Priority Data
Jun. 30, 2010 (JP) 2010-149490

(51) Int. Cl. G06K 15/02

(52) U.S. Cl. 358/1.15

(57) ABSTRACT

An image formation apparatus includes: a controller operable to control a transition among a normal mode to operate the image formation apparatus, a first power saving mode in which electric power less than the normal mode is supplied, and a second power saving mode different from the first power saving mode in which electric power less than the normal mode is supplied; and an abnormality detector configured to detect an abnormality in the image formation apparatus. On the basis of the detection result of the abnormality detector, the controller controls transition to either the first power saving mode or the second power saving mode.

### CROSS REFERENCE TO RELATED APPLICATIONS

This application claims priority based on 35 USC 119 from prior Japanese Patent Application No. 2010149490 filed on Jun. 30, 2010, entitled “Image Formation Apparatus”, the entire contents of which are incorporated herein by reference.

### BACKGROUND OF THE INVENTION

1. Field of the Invention

The invention relates to an image formation apparatus capable of reducing power consumption, for example, an image formation apparatus having a power saving function to omit or reduce electric power supplied to a power supply destination(s).

2. Description of Related Art

A conventional image formation apparatus having a power saving mode to reduce power consumption is disclosed (see, Japanese Patent Application Laid-Open No. 2007-268786, paragraphs 0020 to 0027), which switches from a normal mode for a printing and waiting state to a power saving mode whose electric power consumption is less than that of the normal mode by stopping electric power supply to an image formation unit after waiting for a predetermined time in the normal mode.

### SUMMARY OF THE INVENTION

However, in the conventional image formation apparatus, the apparatus does not switch the image formation unit to the power saving mode, even through an abnormality (error) such as a toner shortage, a jam in a medium conveyance path, or the like is detected in the normal mode, which means that the image formation unit is in a state of being unable to form an image on the medium in the normal mode. Accordingly, the power saving effect of the conventional image formation apparatus is relatively ineffective.

An aspect of the invention is an image formation apparatus including: a controller operable to control transition among a normal mode to operate the image formation apparatus, a first power saving mode in which electric power less than the normal mode is supplied, and a second power saving mode different from the first power saving mode in which electric power less than the normal mode is supplied; and an abnormality detector configured to detect an abnormality in the image formation apparatus. On the basis of a detection result of the abnormality detector, the controller controls transition to either the first power saving mode or the second power saving mode.

### BRIEF DESCRIPTION OF THE DRAWINGS

FIG. 1 is a block diagram illustrating an image formation apparatus according to a first embodiment.

FIG. 2 is a state transition diagram illustrating the relationship between a normal mode, a first power saving mode, and a second power saving mode executed by the image formation apparatus according to the first embodiment.

FIG. 3 is a sectional view schematically illustrating the image formation unit shown in FIG. 1.

FIG. 4 is a flow chart illustrating operation of the normal mode, which is step S100 shown in FIG. 2, executed by the image formation apparatus.

FIG. 5 is a flow chart illustrating operation of the first power saving mode, which is step S200 shown in FIG. 2, in the image formation apparatus.

FIG. 6 is a flow chart illustrating operation of the second power saving mode, which is step S300 shown in FIG. 2, in the image formation apparatus.

FIG. 7 is a state transition diagram illustrating the relationship between a normal mode, a first power saving mode, and a second power saving mode executed by an image formation apparatus according to a second embodiment.

### DETAILED DESCRIPTION OF THE EMBODIMENTS

Descriptions are provided herein below for embodiments based on the drawings. All of the drawings are merely schematically illustrated for an understanding of the invention. All of the drawings are provided to illustrate the respective examples only. In the respective drawings referenced herein, the same constituents are designated by the same reference numerals and duplicate explanation concerning the same constituents is omitted.

### First Embodiment

[Configuration of Image Formation Apparatus]

Image formation apparatus 1 according to the first embodiment is, for example, an electrographic recording printer, facsimile machine, copy machine, MFP (Multifunction Peripheral), or the like and may be an image formation apparatus of any other type.

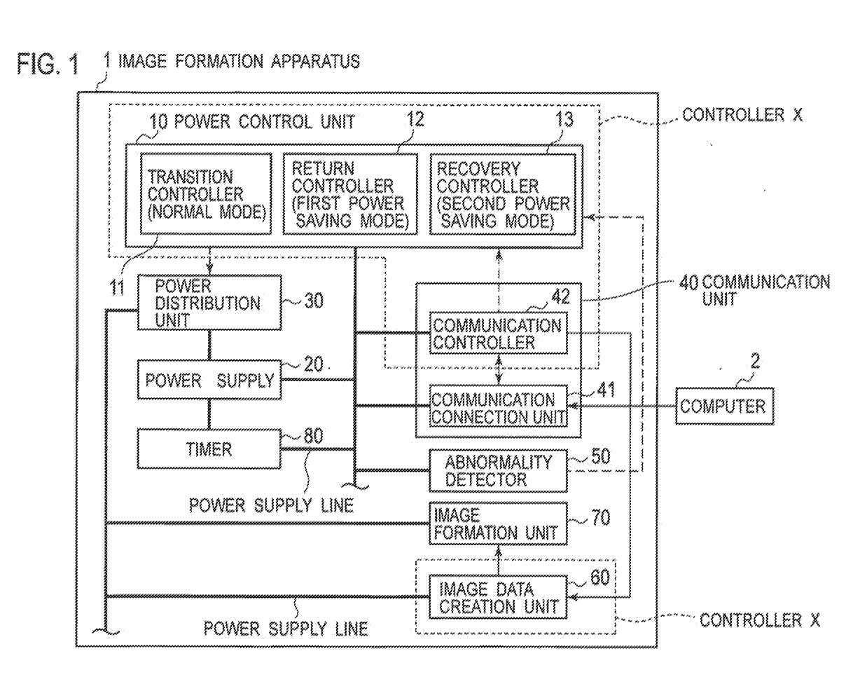

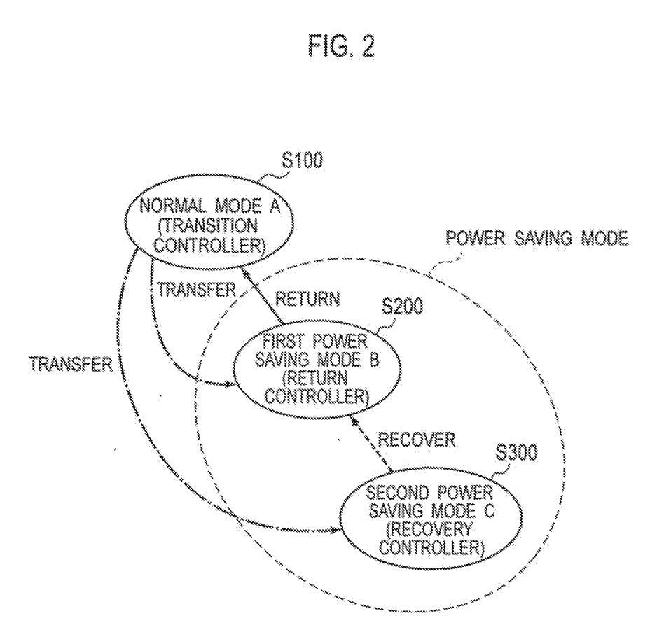

As shown in FIG. 1, image formation apparatus 1 includes power control unit 10, power supply 20, power distribution unit 30, communication unit 40 (communication detector), abnormality detector 50, image data creation unit 60 configured to create image data from print data, image formation unit 70 such as a print engine configured to form an image according to the image data on recording media such as sheets of paper, and timer 80. As shown in FIG. 2, image formation apparatus 1 operates in a normal mode or a power saving mode (including a first power saving mode and a second power saving mode).

Image formation apparatus 1 determines whether abnormality detector 50 detects any abnormality when a predetermined condition is satisfied in the normal mode, and then switches from the normal mode to the first power saving mode when abnormality detector 50 does not detect any abnormality and switches from the normal mode to the second power saving mode when abnormality detector 50 detects an abnormality. Image formation apparatus 1 switches (returns) to the normal mode from the first power saving mode, when communication unit 40 detects reception of print data during the first power saving mode. Image formation apparatus 1 switches (recovers) to the first power saving mode from the second power saving mode, when abnormality detector 50 detects that the abnormality is resolved in the second power saving mode.

In the normal mode, image formation apparatus 1 is capable of supplying electric power to components, including image formation unit 70, of image formation apparatus 1, causing image data creation unit 60 to create image data based on print data received from communication unit 40, and then causing image formation unit 70 to form an image according to the image data on a recording medium.

In the first power saving mode, image formation apparatus 1 reduces the entire power consumption of image formation apparatus 1 by not supplying electric power to image data creation unit 60 and image formation unit 70. In the second power saving mode, image formation apparatus 1 reduces the entire power consumption of image formation apparatus 1 by not supplying electric power to image data creation unit 60 and image formation unit 70. In the second power saving mode, image formation apparatus 1 causes communication unit 40 to discard received print data since image formation apparatus 1 has an abnormality detected by abnormality detector 50.

(Power Supply 20)

Power supply 20 supplies electric power to each component of image formation apparatus 1 via power supply line(s).

(Power Distribution Unit 30)

Power distribution unit 30 is interposed between power supply 20 and image data creation unit 60 and between power supply 20 and image formation unit 70 and is connected to power supply 20, image data creation unit 60, and image formation unit 70 via the power supply lines. Power distribution unit 30 is controlled by power control unit 10 and functions as a switch to switch between supplying (switching ON) and not supplying (switching OFF) electric power from power supply 20 to image data creation unit 60 and image formation unit 70. Power distribution unit 30 of the first embodiment is controlled by power control unit 10 to operate in a switched-ON state during the normal mode whereas to operate in a switched-OFF state during the power saving mode (the first power saving mode and the second power saving mode). Note that image data creation unit 60 and image formation unit 70 may be supplied with a minimum required electric power such as a standby power, when power distribution unit 30 is in the switched-OFF state.

(Image Data Creation Unit 60)

Image data creation unit 60 is supplied with electric power from power distribution unit 30 and, in the normal mode, obtains print data output from communication controller 42, creates image data according to the print data, and outputs the image data to image formation unit 70.

(Image Formation Unit 70)

Image formation unit 70 is configured, upon being supplied with electric power via power distribution unit 30, to form, on recording medium 73 such as a sheet, an image corresponding to the image data output from image data creation unit 60. That is, image formation unit 70 does not operate in the power saving mode (the first power saving mode and the second power saving mode) when electric power is not supplied to image formation unit 70, whereas image formation unit 70 operates in the normal mode when electric power is supplied to image formation unit 70.

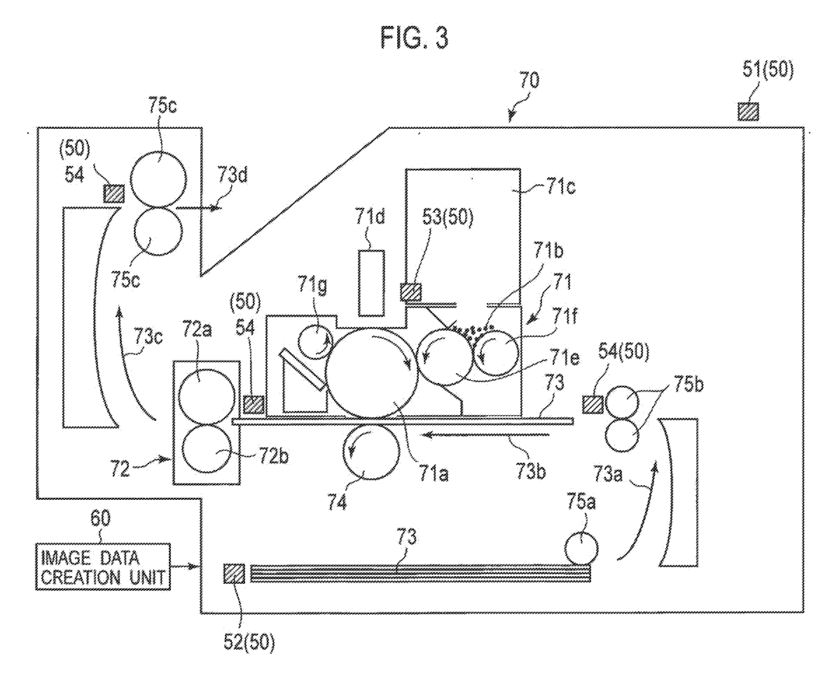

As shown in FIG. 3, image formation unit 70 includes: an unillustrated controller which controls the entire operation of image formation unit 70; development unit 71; fixation unit 72; image transfer roller 74 disposed facing photosensitive drum 71a and configured to transfer a toner image or a developer image developed by development unit 71 onto recording medium 73 that is being conveyed; and medium conveyance rollers 75a, 75b, and 75c. Image formation unit 70 also includes abnormality detectors 50 (cover open/close sensor 51, tray sensor 52, toner sensor 53, and medium conveyance sensor 54) to be described later in detail.

Development unit 71 includes therein: toner cartridge 71c or a developer container containing therein toner 71b or developer; photosensitive drum 71a on which an electrostatic latent image can be formed by LED head 71d serving as a latent image formation device or an exposure device; development roller 71e rotatably disposed facing photosensitive drum 71a and configured to render visible the electrostatic latent image on photosensitive drum 71a with toner or developer thereby forming a toner image or a developer image; supply roller 71f configured to move (supply) toner 71b from inside of toner cartridge 71c to development roller 71e; charging roller 71g configured to charge photosensitive drum 71a; and etc.

Note that recording medium 73 is conveyed along the directions denoted by arrows 73a, 73b, 73c, and 73d. Image transfer roller 74 functions to transfer the toner image that is formed on photosensitive drum 71a onto recording medium 73. The toner image that is transferred onto recording medium 73 is fixed to recording medium 73 by means of fixation unit 72.

LED head 71d exposes the surface of photosensitive drum 71a by selectively emitting light from LEDs according to an image formation pattern of the image, thereby forming the electrostatic latent image on the surface of photosensitive drum 71a. Photosensitive drum 71a includes: a metal cylinder serving as an electrically-conductive supporting body; and a photovoltaic layer which is formed by sequentially coating a charge generation layer and a charge transport layer on the metal pipe, such that photosensitive drum 71 is an organic photoreceptor. Charging roller 71g includes a rotatable metal shaft with an elastic layer coating over the metal shaft and functions to charge photosensitive drum 71a.

Development roller 71e functions to attach toner 71b to the electrostatic latent image on photosensitive drum 71a thereby rendering visible the electrostatic latent image with toner 71b. Bias voltage is applied to supply roller 71f and development roller 71e from a high-voltage power supply so that an electric field moves toner 71b to development roller 71e to execute development. Fixation unit 72 has heat roller 72a and fixation roller 72b disposed facing each other and fixes the toner image on recording medium 73 by heating and pressing the toner image. Heat roller 72a includes therein a heating element such as a halogen lamp and its temperature is precisely controlled. In order to shorten the time interval from the time when the apparatus is returned from the first power saving mode to the normal mode to the time when image formation unit 70 starts to form the image on recording medium 73, it is preferred that the temperature of heat roller 72a of the first embodiment is maintained at a certain level using standby electric power supplied to image formation unit 70. In image formation apparatus 1 of the first embodiment, during the power saving mode, power distribution unit 30 does not supply electric power to drive motors to rotate various rollers such as photosensitive drum 71a, development roller 71e, and the like and high-voltage electric power. Therefore, a high power-saving effect is obtained.

Image formation unit 70 having the above-described configuration controls LED head 71d to selectively emit light, on the basis of image data output from image data creation unit 60, onto the surface of photosensitive drum 71a that is uniformly charged by charging roller 71g, thereby forming the electrostatic latent image on the charged surface of photosensitive drum 71a. Then, image formation unit 70 controls development roller 71e, image transfer roller 74, and fixation unit 72 to form the image on recording medium 73 according to the image data.

(Abnormality Detector 50)

Abnormality detector 50 is supplied with electric power directly from power supply 20 without power distribution unit 30, detects the occurrence of an abnormality (an error) in components of image formation apparatus 1 and a cessation (resolution) of the abnormality, and outputs an abnormality detection signal (Alarm Mode-P signal) being a binary signal to power control unit 10. Here, abnormality detector 50 of the first embodiment outputs the abnormality detection signal of an “H” (High) value or an “L” (Low) value. Upon detection of an occurrence of an abnormality, abnormality detector 50 outputs the abnormality detection signal of “H” to power control unit 10. On the other hand, upon detection of cessation of the abnormality, abnormality detector 50 outputs the abnormality detection signal of “L”, which means an abnormality cessation signal, to power control unit 10.

The abnormality to be detected by abnormality detector 50 is an error that causes image formation unit 70 to be unable to form the image. The abnormality may be a critical error which is resolved only by a reset of the apparatus, for example, by turning off the power to image data creation unit 60 or image formation unit 70. However, it is preferred that abnormality detector 50 is able to detect an occurrence and cessation of the abnormality even when image formation unit 70 is not supplied with electric power. For example, cover open/close sensor 51, tray sensor 52, toner sensor 53, medium conveyance sensor 54, or the like provided in image formation unit 70 are all abnormality detectors 50, as shown in FIG. 3.

Cover open/close sensor 51 detects an open (abnormality) or a closed (normality) state of the printer cover. The printer cover is attached to the body of the apparatus and can be opened or detached when recording medium 73 such as a print paper gets jammed in image formation unit 70. Tray sensor 52 detects existence (normality) or nonexistence (abnormality) of recording medium 73 in the tray. Toner sensor 53 detects the amount of toner remaining in toner cartridge 71c, which is to be transferred onto recording medium 73 for image formation, and detects if the amount of remaining toner is sufficient (normality) or insufficient (abnormality). Medium conveyance sensor 54 is provided at midstream of medium conveyance path extending from the upstream end (the tray) to the downstream end (the stacker) to which recording medium 73 is discharged, and detects if recording medium 73 gets jammed (abnormality) or not (normality). Medium conveyance sensor 54 detects abnormality when recording medium 73 gets jammed but normality when jammed recording medium 73 is removed.

(Timer 80)

Timer 80 is supplied with electric power directly by power supply 20 and measures (counts) a time interval.

(Communication Unit 40)

Communication unit 40 (communication detector) is supplied with electric power directly from power supply 20. Communication unit 40 includes: communication connection unit 41 to be communicatably connected to computer 2; and communication controller 42 to control transmission and reception of data at communication connection unit 41. Communication connection unit 41 is connected to computer 2 via a wired network or a wireless network, for example, LAN (Local Area Network), USB (Universal Serial Bus), Bluetooth (registered trademark), or the like. Upon reception of data from computer 2, communication connection unit 41 outputs an interrupt signal to communication controller 42. When the received data is print data including an instruction to form an image, communication controller 42 outputs a signal (a print data reception signal) indicating the reception of the print data to power control unit 10. After that, if the apparatus is operating in the normal mode, communication controller 42 outputs the print data to image data creation unit 60. On the other hand, if the apparatus is operating in the second power saving mode, power control unit 10 (recovery controller 13) transmits a discard instruction, and communication controller 42 discards the received print data, based on the discard instruction.

When the print data is received, communication controller 42 causes timer 80 to start to measure a time interval. When the next print data is received, communication controller 42 causes timer 80 to reset the measured time interval and to start to measure a time interval from zero. With this operation, a time interval starting from the reception of the last print data is obtained.

(Power Control Unit 10)

Power control unit 10 is supplied with electric power directly from power supply 20. Power control unit 10 controls power distribution unit 30 to supply (turn on) and to shut off (turn off) electric power supplied from power supply 20 to image data creation unit 60 and image formation unit 70. In the first embodiment, power control unit 10 outputs Power Save-N signal to control power distribution unit 30. When Power Save-N signal is “H”, power distribution unit 30 supplies electric power (switch-ON), whereas when Power Save-N signal is “L”, power distribution unit 30 shuts off electric power (switch-OFF). Power control unit 10 includes: transition controller 11 to switch from the normal mode to the first power saving mode or the second power saving mode; return controller 12 to switch (return) from the first power saving mode to the normal mode; and recovery controller 13 to switch (recover) from the second power saving mode to the first power saving mode.

(Transition Controller 11)

Upon an execution instruction from return controller 12, transition controller 11 starts processing and operates image formation apparatus 1 in the normal mode. Therefore, image formation apparatus 1 (image data creation unit 60 and image formation unit 70) operating in the normal mode is able to form, on recording medium 73, an image according to the print data received from communication unit 40 (communication connection unit 41).

Then, when the predetermined condition is satisfied, transition controller 11 outputs Power Save-N signal of “L” to power distribution unit 30. With this operation, power distribution unit 30 switches off and shuts off electric power supply from power supply 20 to image data creation unit 60 and image formation unit 70. Next, transition controller 11 determines whether abnormality detector 50 detects an abnormality or not. When the value of the abnormality detection signal is “L”, which means that no abnormality is detected, transition controller 11 causes return controller 12 to start to operate, to switch to the first power saving mode. On the other hand, when the value of the abnormality detection signal is “H”, which means that an abnormality is detected, transition controller 11 causes recovery controller 13 to start to operate, to switch to the second power saving mode.

Here, the predetermined condition in this embodiment is the elapse of a predetermined time interval after communication unit 40 received the last print data. Accordingly, for example, transition controller 11 obtains a measured time interval from timer 80 and compares the measured time interval with the predetermined time interval, to determine whether or not the predetermined condition is satisfied. Data of the predetermined time interval is previously stored in a memory (not shown) such as a buffer or the like, for example.

(Return Controller 12)

The execution instruction from transition controller 11 brings return controller 12 into operation and thus return controller 12 operates image formation apparatus 1 in the first power saving mode. When return controller 12 receives the print data reception signal from communication controller 42, return controller 12 outputs Power Save-N signal of “H” to power distribution unit 30. With this, power distribution unit 30 executes switch-on operation and distributes electric power from power supply 20 to image data creation unit 60 and image formation unit 70. After that, return controller 12 causes transition controller 11 to operate, to switch (return) to the normal mode.

(Recovery Controller 13)

The execution instruction from transition controller 11 brings recovery controller 13 into operation and thus recovery controller 13 operates image formation apparatus 1 in the second power saving mode. Further, when receiving the print data reception signal from communication controller 42, recovery controller 13 outputs the discard instruction. Then, when the value of the abnormality detection signal (Alarm Mode-P signal) output from abnormality detector 50 is “L”, which means that no abnormality is detected, recovery controller 13 causes return controller 12 to operate, to switch (recover) to the first power saving mode.

Here, the controller (X) of image formation apparatus 1 is includes power control unit 10, communication controller 42, image data creation unit 60, and the like and is enabled by CPU (Central Processing Unit), ROM (Read Only Memory), RAM (Random Access Memory), and a program(s).

Image formation apparatus 1 having the above described configuration according to the first embodiment switches to the power saving mode from the normal mode, if a waiting period, which is a period in which communication unit 40 does not receive print data in the normal mode, is excessively long. Here, when the operation is switched from the normal mode to the power saving mode by transition controller 11, the supply of electric power to image data creation unit 60 and image formation unit 70 is stopped. Then, in the case where no abnormality is detected, this embodiment causes return controller 12 to operate, thereby switching to the first power saving mode. On the other hand, in the case where an abnormality is detected, this embodiment causes recovery controller 13 to operate, thereby switching to the second power saving mode.

Return controller 12 causes image formation apparatus 1 to operate in the first power saving mode, thereby not supplying electric power to image data creation unit 60 and image formation unit 70. Therefore, the entire power consumption of image formation apparatus 1 is reduced. Until print data is received from computer 2, return controller 12 keeps image formation apparatus 1 from returning to the normal mode, thereby maintaining the power saving state.

Recovery controller 13 causes image formation apparatus 1 to operate in the second power saving mode, thereby not supplying electric power to image data creation unit 60 and image formation unit 70. Therefore, the entire power consumption of image formation apparatus 1 is reduced. Then, until an abnormality is resolved, recovery controller 13 keeps image formation apparatus from recovering to the first power saving mode, thereby maintaining the power saving state.

As described above, image formation apparatus 1 of the first embodiment transfers to the power saving mode from the normal mode even through an abnormality is detected in the normal mode, thereby improving the power saving effect. Further, image formation apparatus 1 of the first embodiment does not return to the normal mode from the power saving mode if the abnormality is not resolved in the power saving mode. Therefore, image formation apparatus 1 is not operated in the normal mode, in a state where image formation apparatus 1 is unable to print. Consequently, this embodiment further improves the power saving effect.

[Normal Mode]

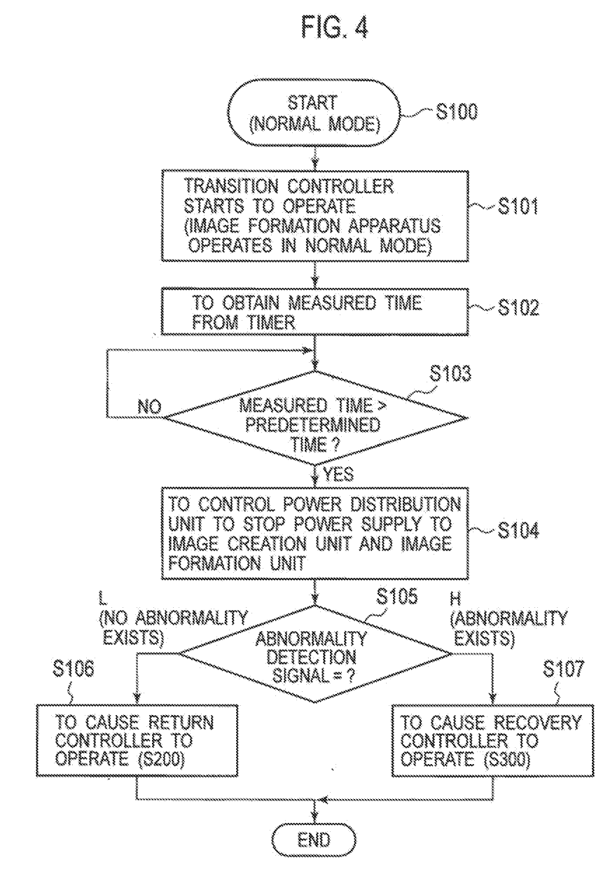

Next, image formation apparatus 1 operating in the normal mode, which is step S100 in FIG. 2, will be described with reference to FIG. 4 (see FIGS. 1 and 2).

By bringing transition controller 11 into operation (step S101), image formation apparatus 1 operates in the normal mode. In image formation apparatus 1 operating in the normal mode, power distribution unit 30 executes the switch-on operation, that is, electric power is supplied to image data creation unit 60 and image formation unit 70, and electric power is also supplied to the other components of image formation apparatus 1 from power supply 20. Meanwhile, abnormality detector 50 outputs the abnormality detection signal of “L” (no abnormality). In this normal mode, if print data is received from computer 2, image data creation unit 60 obtains the print data from communication controller 42 and creates image data based on the print data, and then image formation unit 70 forms an image on recording medium 73.

Then, transition controller 11 obtains (step S102) a measured time interval from timer 80 and compares (step S103) the measured time interval with the predetermined time interval (the measured time interval>the predetermined time interval?).

In the case (step S103, No) where the measured time interval is equal to or less than the predetermined time interval (the measured time interval≦the predetermined time interval), transition controller 11 waits and proceeds back to step S103. On the other hand, in the case (step S103, Yes) where the measured time is larger than the predetermined time interval (the measured time interval>the predetermined time interval), transition controller 11 outputs Power Save-N signal of “L” to power distribution unit 30 to control power distribution unit 30 to be switched off thereby stopping electric power supply from power supply 20 to image data creation unit 60 and image formation unit 70 (step S104).

Next, transition controller 11 determines the value of the abnormality detection signal (Alarm Mode-P signal) output from abnormality detector 50 (step S105). In the case where the abnormality detection signal is “L” (step S105, L (no abnormality)), transition controller 11 causes return controller 12 to operate (step S106) (step S200, FIG. 2). On the other hand, in the case where the abnormality detection signal is “H” (step S105, H (abnormality)), transition controller 11 causes recovery controller 13 to operate (step S107) (step S300, FIG. 2). With this, image formation apparatus 1 ends the normal mode.

[First Power Saving Mode]

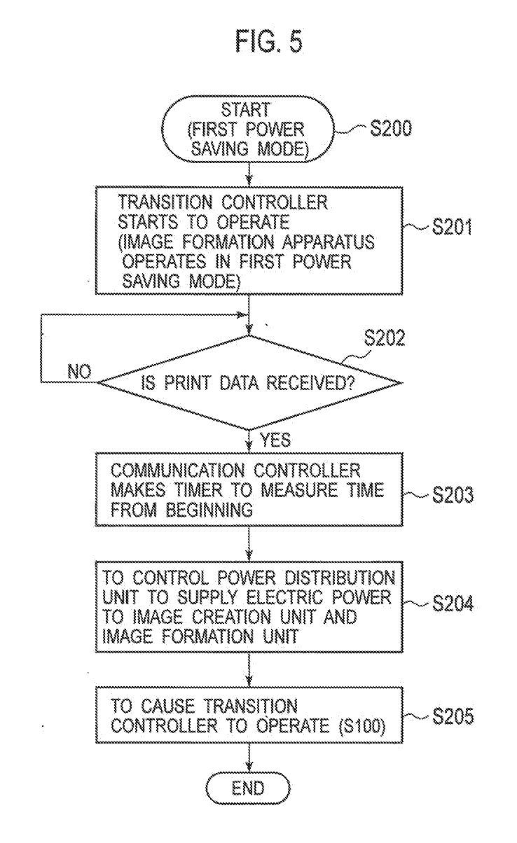

Next, image formation apparatus 1 operating in the first power saving mode, which is step S200 in FIG. 2, will be described with reference to FIG. 5 (see FIGS. 1 and 2).

By bringing return controller 12 into operation (step S201), image formation apparatus 1 operates in the first power saving mode. In image formation apparatus 1 operating in the first power saving mode, power distribution unit 30 executes the switch-off operation, that is, electric power is not supplied to image data creation unit 60 and image formation unit 70. In the first power saving mode, the abnormality detection signal of “L” (no abnormality) is output from abnormality detector 50.

Return controller 12 determines whether communication unit 40 receives print data from computer 2. That is, return controller 12 determines whether return controller 12 receives the print data reception signal output from communication controller 42 (step S202). In the case where return controller 12 does not receive the print data reception signal (step S202, No), return controller 12 waits and proceeds back to step S202. On the other hand, in the case where return controller 12 receives the print data reception signal (step S202, Yes), communication controller 42 resets the measured time interval in timer 80 and restarts to measure a time interval (step S203). Then, return controller 12 outputs Power Save-N signal of “H” to power distribution unit 30 to control power distribution unit 30 to execute the switch-on operation, thereby supplying electric power from power supply 20 to image data creation unit 60 and image formation unit 70 (step S204). Next, return controller 12 causes transition controller 11 to operate (step S205) (step S100 in FIG. 2). With this, image formation apparatus 1 ends the first power saving mode.

[Second Power Saving Mode]

Next, image formation apparatus 1 operating in the second power saving mode, which is step S300 in FIG. 2, will be described with reference to FIG. 5 (arbitrarily see FIGS. 1 and 2). First, by bringing recovery controller 13 into operation (step S301), image formation apparatus 1 operates in the second power saving mode. In image formation apparatus 1 operating in the second power saving mode, power distribution unit 30 executes the switch-off operation and thus electric power is not supplied to image data creation unit 60 and image formation unit 70. Further, in the second power saving mode, the abnormality detection signal of “H” (abnormality) is output from abnormality detector 50.

Recovery controller 13 determines the value of the abnormality detection signal (Alarm Mode-P signal) output from abnormality detector 50 (step S302). In the case where the abnormality detection signal is “H” (step S302, H (abnormality)), recovery controller 13 waits and proceeds back to step S302. On the other hand, in the case where the abnormality detection signal is “L” (step S302, L (no abnormality)), recovery controller 13 causes return controller 12 to operate (step S303) (step S200, FIG. 2). This causes image formation apparatus 1 to end the operation in the second power saving mode, and switches to the first power saving mode. Here, in the second power saving mode, the print data received by communication unit 40 is discarded, which prevents the apparatus from executing the print process for the received print data in the abnormal state.

According to this embodiment, when an abnormality in the image formation apparatus is resolved in the second power saving mode, the image formation apparatus is not switched directly to the normal mode whose power consumption is high but is switched to the first power saving mode whose power consumption is less than that of the normal mode. That is, when the abnormality in the image formation apparatus is resolved, this embodiment prevents the image formation apparatus from being switched from the abnormal state to the normal mode whose power consumption is wastefully high but this embodiment switches the image formation apparatus to the first power saving mode, which is a power saving mode for no-abnormality state, thereby enhancing the power saving effect.

### Second Embodiment

Image formation apparatus 1 of the second embodiment includes the same configuration as image formation apparatus 1 of the first embodiment shown in FIG. 1, and a duplicate explanation regarding the same configurations as and configurations having the same functions as the first embodiment will be omitted.

(Return Controller 12)

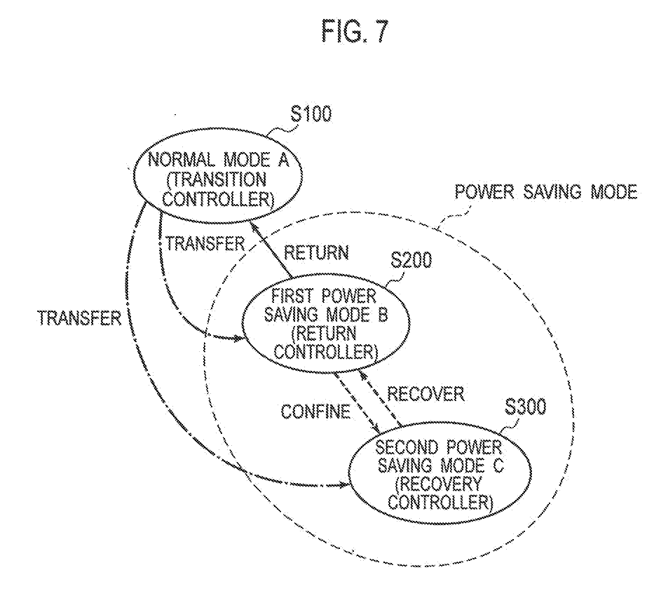

Return controller 12 of the second embodiment has the same functions as return controller 12 of the first embodiment. In addition to the same functions, return controller 12 of the second embodiment has another function to execute an interrupt processing to cause recovery controller 13 to operate, when abnormality detector 50 detects the occurrence of an abnormality (when return controller 12 receives the abnormality detection signal (Alarm Mode-P signal) of “H”) in the first power saving mode. That is, as shown in FIG. 7, image formation apparatus 1 of the second embodiment has a function to switch (confine) image formation unit 70 to the second power saving mode from the first power saving mode.

Accordingly, image formation apparatus 1 of the second embodiment having the above described configuration is capable of switching (confining) to the second power saving mode when an abnormality is detected in the first power saving mode. That is, recovery controller 13 operating in the second power saving mode prevents from recovering to the first power saving mode until the abnormality is resolved, thereby keeping the power saving mode. Further, according to image formation apparatus 1 of the second embodiment, even when an abnormality occurs in the first power saving mode, it is prevented from returning to the normal mode until the abnormality is resolved. Therefore, operating in the normal mode is not allowed in the state where the apparatus cannot execute printing. Consequently, the second embodiment further improves the power saving effect.

### Third Embodiment

Image formation apparatus 1 of a third embodiment includes the same configurations as the image formation apparatus 1 of the first embodiment shown in FIG. 1, so a duplicate explanation regarding the same configurations as and configurations having the same function as the first embodiment will be omitted.

(Recovery Controller 13)

Recovery controller 13 in the third embodiment includes the same functions as recovery controller 13 in the first embodiment. In addition to the same functions, recovery controller 13 in the third embodiment includes another function, when the print data reception signal is received from communication controller 42, to create discard instruction data in which a discard instruction to discard the print data and information of an abnormality that currently exists are described and to output the discard instruction data to communication controller 42. Here, the information of the currently existing abnormality is the information of the abnormality detected by abnormality detector 50, including the name of the sensor that detects the abnormality, the place where the abnormality is detected, and/or the like.

(Communication Controller 42)

Communication controller 42 in the third embodiment includes the same functions as communication controller 42 in the first embodiment. In addition to the same functions, communication controller 42 in the third embodiment includes another function to, based on the discard instruction data obtained from recovery controller 13, create abnormality reporting data regarding the currently existing abnormality detected by abnormality detector 50 and to control communication connection unit 41 to transmit the created abnormality reporting data to computer 2 which is the sender of the print data.

According to image formation apparatus 1 of the third embodiment having the above described configuration, a user who obtains the abnormality reporting data with such computer 2 is able to resolve the abnormality in the image formation apparatus 1, based on the sensor name, the place where the abnormality is detected, or/and the like described in the abnormality reporting data. Therefore, the third embodiment can urge the user to take recovery steps to recover the apparatus from the second power saving mode to the first power saving mode.

Although the embodiments according to the invention are described above, the invention is not limited to the above described embodiments and may include other arbitrarily modified or changed embodiments. For example, when the print data is received in the second power saving mode, the communication controller according to the first and second embodiments may discard the received print data without creating the print data reception signal.

For example, in the above embodiments, power distribution unit 30 is connected to image data creation unit 60 and image formation unit 70 and controls electric power supply to these units 60 and 70. This is because a large enhancement of the power saving effect is achieved by setting electric power to be supplied to image data creation unit 60 and image formation unit 70 to almost zero in specific situations. Therefore, in order to shorten the time interval from the time when returning to the normal mode from the first power saving mode to the time when an image is formed on recording medium 73 by image formation unit 70, image data creation unit 60 may be directly connected with power supply 20 so that electric power may be directly supplied from power supply 20 to image data creation unit 60 without power distribution unit 30.

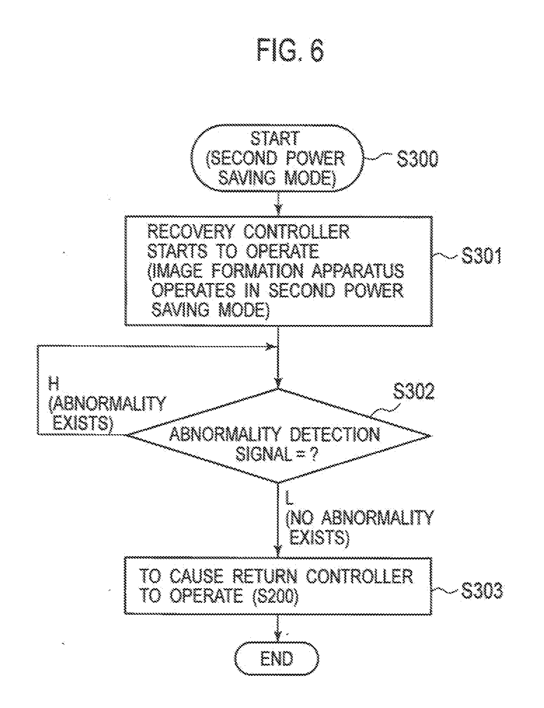

The step (step S104 in FIG. 4) of “controlling power distribution unit 30 to stop electric power supply to image data creation unit 60 and image formation unit 70” operated by transition controller 11 may be executed immediately after return controller 12 starts to operate (immediately after step S201 in FIG. 5) and immediately after recovery controller 13 starts to operate (immediately after step S301 in FIG. 6).

The step (step S204 in FIG. 5) of “controlling power distribution unit 30 to supply electric power to image data creation unit 60 and image formation unit 70” operated by return controller 12 may be executed immediately after transition controller 11 starts to operate (immediately after step S101 in FIG. 4).

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. An image formation apparatus comprising:
a controller operable to control a transition among a normal mode to operate the image formation apparatus, a first power saving mode in which electric power less than the normal mode is supplied, and a second power saving mode, different from the first power saving mode, in which electric power less than the normal mode is supplied; and
an abnormality detector configured to detect an abnormality in the image formation apparatus, wherein, on the basis of a detection result of the abnormality detector, the controller controls transition to either the first power saving mode or the second power saving mode.

2. The image formation apparatus according to claim 1, wherein
upon transition from the normal mode to either of the first power saving mode or the second power saving mode, the controller switches to the first power saving mode when no abnormality is detected by the abnormality detector and switches to the second power saving mode when an abnormality is detected by the abnormality detector.

3. The image formation apparatus according to claim 1, further comprising
a communication detector to detect reception of print data,
wherein the controller switches to the normal mode when the communication detector detects reception of the print data in the first power saving mode.

4. The image formation apparatus according to claim 1, further comprising
a power supply configured to supply electric power to the abnormality detector, wherein electric power is supplied to the abnormality detector even in the second power saving mode.

5. The image formation apparatus according to claim 1, wherein
the controller switches to the first power saving mode when no abnormality is detected by the abnormality detector in the second power saving mode.

6. The image formation apparatus according to claim 4, wherein
the controller switches to the first power saving mode when no abnormality is detected by the abnormality detector in the second power saving mode.

7. The image formation apparatus according to claim 1, wherein
the controller switches to the second power saving mode when an abnormality is detected by the abnormality detector in the first power saving mode.

8. The image formation apparatus according to claim 1, wherein
the controller switches to the second power saving mode when an abnormality is detected by the abnormality detector in the first power saving mode, and
the controller switches to the first power saving mode when no abnormality is detected by the abnormality detector in the second power saving mode.

9. The image formation apparatus according to claim 1, further comprising
a communication detector to detect reception of print data,
wherein the controller switches to the normal mode when the communication detector detects the reception of the print data in the first power saving mode,
the controller switches to the second power saving mode when an abnormality is detected by the abnormality detector in the first power saving mode, and
the controller switches to the first power saving mode when no abnormality is detected by the abnormality detector in the second power saving mode.

10. The image formation apparatus according to claim 1, further comprising
a communication detector to detect reception of print data,
wherein upon the reception of the print data, the controller controls the communication detector to discard the print data.

11. The image formation apparatus according to claim 10, further comprising
a communication connection unit configured to communicate with an external terminal,
wherein the communication detector discards the print data and transmits abnormality reporting data via a communication connection unit to the external terminal.

12. The image formation apparatus according to claim 1, further comprising
a communication detector to detect reception of print data; and
a timer configured to measure a time interval from the time when the communication detector receives the print data,
wherein when the measured time of the timer exceeds a predetermined time interval in the normal mode, the controller switches from the normal mode to the first power saving mode.
